(19) United States
(12) Patent Application Publication
(10) Pub. No.: US 2009/0144959 A1
(43) Pub. Date: Jun. 11, 2009

(54) Method for assembly of a direct injection fuel rail

(76) Inventors: Michael J. Colletti, Churchville, NY (US); Kristopher J. Duell, Brockport, NY (US)

Correspondence Address: DELPHI TECHNOLOGIES, INC., M/C 480-410-202, PO BOX 5052, TROY, MI, 48007, US

(21) Appl. No.: 12/001,435

(22) Filed: Dec. 11, 2007

(51) Int. Cl. B23K 1/00

(52) U.S. Cl. 29/428; 228/245; 29/890.054

(57) ABSTRACT

A method for assembling a direct injection fuel rail of an internal combustion engine includes the steps of: designing a fuel distribution tube having a first radius, mating a fuel rail component having a second radius that is different from the first radius with the fuel distribution tube, forming at least one projection point where the fuel rail component contacts the fuel distribution tube, consuming the at least one projection point during a resistance welding process, and forming a temporary bond between the fuel rail component and the fuel distribution tube. By intentionally mismatching the radii of fuel rail components, projection points are created that can be consumed during a resistance welding process. As the projection points are consumed, a temporary bond is formed between the fuel distribution tube and the fuel rail component, and a braze joint gap is optimized, which enables formation of a high quality braze joint.

### TECHNICAL FIELD

The present invention relates to fuel rail assemblies for supplying fuel to fuel injectors of internal combustion engines; more particularly, to fuel rail assemblies for supplying fuel for direct injection of gasoline (DIG) or of diesel fuel (DID) into engine cylinders; and most particularly, to an improved method for assembling a direct injection fuel rail assembly.

### BACKGROUND OF THE INVENTION

Fuel rails for supplying fuel to fuel injectors of internal combustion engines are well known. A fuel rail assembly, also referred to herein simply as a fuel rail, is essentially an elongate tubular fuel manifold connected at an inlet end to a fuel supply system and having a plurality of ports for mating in any of various arrangements with a plurality of fuel injectors to be supplied. Typically, a fuel rail assembly includes a plurality of fuel injector sockets in communication with a manifold supply tube, the injectors being inserted into the sockets and held in place in an engine head by bolts securing the fuel rail assembly to the head.

Gasoline fuel injection arrangements may be divided generally into multi-port fuel injection (MPFI), wherein fuel is injected into a runner of an air intake manifold ahead of a cylinder intake valve, and direct injection gasoline (DIG), wherein fuel is injected directly into the combustion chamber of an engine cylinder, typically during or at the end of the compression stroke of the piston. DIG is designed to allow greater control and precision of the fuel charge to the combustion chamber, resulting in better fuel economy and lower emissions. This is accomplished by enabling combustion of an ultra-lean mixture under many operating conditions. DIG is also designed to allow higher compression ratios, delivering higher performance with lower fuel consumption compared to other fuel injection systems. Diesel fuel injection (DID) is also a direct injection type.

For purpose of clarity and brevity, wherever DIG is used herein it should be taken to mean that both DIG and DID, and fuel rail assemblies in accordance with the invention as described below are useful in both DIG and DID engines.

A DIG fuel rail must sustain much higher fuel pressures than a MPFI fuel rail to assure proper injection of fuel into a cylinder having a compressed charge during the compression stroke. DIG fuel rails may be pressurized to about 100 atmospheres or more, for example, whereas MPFI fuel rails must sustain pressures of only about 4 atmospheres. Error proof braze joints are, therefore, necessary for the assembly of fuel rails.

DIG fuel rails further require high precision in the placement of the injector sockets in the fuel supply tube because the spacing and orientation of the sockets along the fuel rail assembly must exactly match the three-dimensional spacing and orientation of the fuel injectors as installed in cylinder ports in the engine. For example, direct injection fuel rail assemblies typically require injector socket to injector socket true positions of less than about 0.5 mm. Braze joints typically require gaps less than 0.05 mm to approach base metal strength. When utilizing the brazing process for producing direct injection fuel rail assemblies both of these requirements must be met. Typical multi-port fuel rail fabrication components and techniques do not meet these requirements making it necessary to find alternate methods.

For example, matching radii between fuel injector sockets and a fuel distribution tube as well as between mounting bosses and the fuel distribution tube have become common practice. Typically a feature having a radius that matches the radius of the fuel supply tube is added to fuel injector socket and the mounting boss. Prior to a brazing process that permanently assembles the fuel injector sockets and the mounting bosses to the fuel supply tube, typically, a temporary assembly method is applied to hold the mounting bosses and fuel injector sockets on position to the round fuel supply tube until brazing. Such temporary assembly methods typically include, for example, tungsten inert gas welding, metal inert gas welding, and laser tack welding. These welding techniques often require multiple welds to occur simultaneously to avoid distortion due to shrinkage after the weld. Furthermore, these welding techniques require constant maintenance of the welding tool to insure the weld tips and, therefore, the focal length, are set and functioning properly.

Projection welding, a form of resistance welding, where the welds are localized at projections, intersections, or overlaps of the parts to be joined, is a lower cost temporary assembly method that is typically employed in multi-port fuel injection (MPFI) fuel rail manufacturing. Projection welding is used to tack various stamped brackets and fuel injector sockets on location until the final and permanent assembly via brazing can occur. While projection welding is a low cost, highly reliable welding method that requires little maintenance, this temporary assembly method cannot easily be applied to direct injection fuel rail assemblies. Contrary to MPFI fuel rail assembly where projections needed for the projection welding process are simply added to the component during the stamping process adding virtually no cost to the product, forming projections on mating components of a DIG fuel rail assembly typically requires costly secondary operations. Also, the projections themselves may become an impediment to closing the gap between the two components, which may result in sub-optimizing the braze joint and/or adding stack up error to socket position.

What is needed in the art is a method for assembling a direct injection fuel rail assembly that utilizes an inexpensive welding process as a temporary assembly method.

It is a principal object of the present invention to provide an improved method for assembly of a direct injection fuel rail assembly that enables application of a projection welding process prior to a brazing process.

It is a further object of the invention to enable the use of inexpensive parts and welding methods.

### SUMMARY OF THE INVENTION

Briefly described, a direct injection fuel rail assembly includes a fuel distribution tube having a first radius, a fuel injector socket having a second radius, and a mounting boss having a third radius. The radii of the fuel injector socket and the fuel distribution tube as well as the radii of the mounting boss and the fuel distribution tube are mismatched resulting in interferences. The interferences are utilized as projections to be consumed during a resistance welding operation. The projection welding process consumes the high contact points at the fuel distribution tube to injector socket interface and at the fuel distribution tube to mounting boss interface. As the contact points are consumed, the braze joint gap is optimized and the injection weld joint temporality holds the components together on position until a final and permanent braze joint is produced.

If the tolerances of the two mating components, the fuel distribution tube and the injector socket or the fuel distribution tube and the mounting boss, are set properly, a braze joint with base metal strength and optimized true position location of the injector socket and the mounting boss relative to the fuel distribution tube can be achieved with application of the least expensive welding method available.

Furthermore, when scalloped features are formed in the fuel distribution tube rather than the fuel injector socket or mounting boss, as in one embodiment in accordance with the invention, inexpensive mill quality tubing with standard tolerances for the fuel distribution tube, as well as screw machine injector sockets and screw machine mounting bosses may be used. The scalloped features are formed in the fuel distribution tube concurrently along a preset tooling centerline using a multi tooled machining head. This results in an optimized centerline of the scalloped features and eliminated the need to separately form holes for fuel passage into the tube.

### BRIEF DESCRIPTION OF THE DRAWINGS

The present invention will now be described, by way of example, with reference to the accompanying drawings, in which:

FIG. 1 is a top plan view of a direct injection fuel rail assembly, in accordance with a first embodiment of the invention;

FIG. 2 is a cross-sectional view of a direct injection fuel rail assembly taken in front of a fuel injector socket, in accordance with a second embodiment of the invention; and

FIG. 3 is a cross-sectional view of the direct injection fuel rail assembly taken in front of a mounting boss, in accordance with the second embodiment of the invention.

Corresponding reference characters indicate corresponding parts throughout the several views. The exemplification set out herein illustrates preferred embodiments of the invention, in one form, and such exemplification is not to be construed as limiting the scope of the invention in any manner.

### DESCRIPTION OF THE PREFERRED EMBODIMENTS

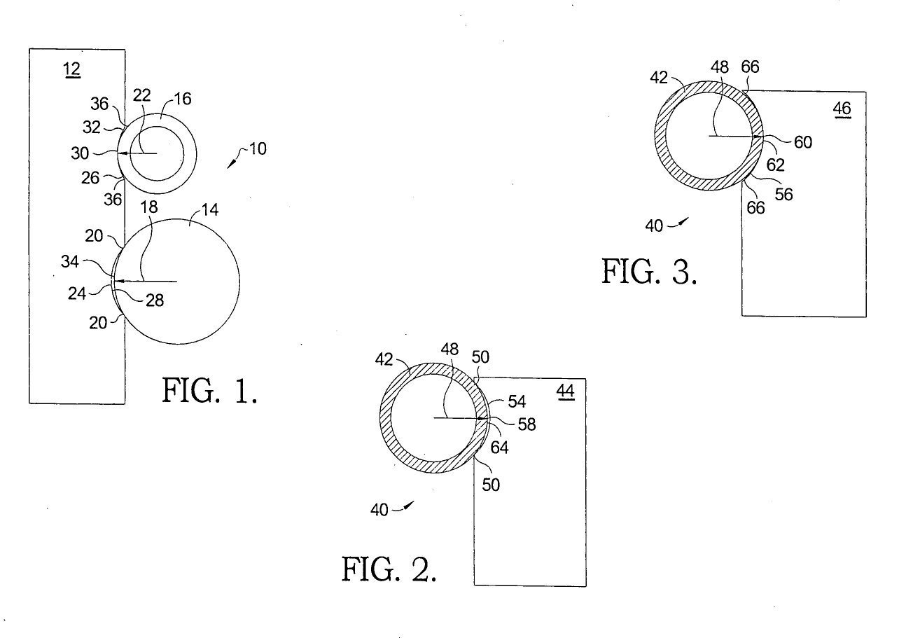

Referring to FIG. 1 a direct injection fuel rail assembly 10 includes a fuel distribution tube 12 having a fuel injector socket 14 and a mounting boss 16 assembled to it. Mounting boss 16 is shown positioned proximate to fuel injector socket 14, but other arrangements may be possible. Even though, only one fuel injector socket 14 and only one mounting boss 16 are illustrated, any desired number of fuel injector sockets 14 and mounting bosses 16 may be assembled to fuel distribution tube 10. Direct injection fuel rail assembly 10 may be part of any kind of direct injection internal combustion engine, for example, DIG and DID engines. Fuel distribution tube 12 may be connected to a fuel supply (not shown) at one end and may include a cap (not shown) at an opposite end.

Fuel distribution tube 12 may be an elongate cylindrical conduit having scalloped features 24 and 26 incorporated. Scalloped features 24 and 26 include a faying surface (not shown) surrounding a center hole (not shown) that enables fluid communication with an interior of fuel distribution tube 12. Scalloped feature 26 receiving mounting boss 16 may also be formed without the center hole.

Scalloped feature 24 is designed to receive fuel injector socket 14. Scalloped feature 24 has a radius 28 that is designed to be smaller than a radius 18 of fuel injector socket 14. As a result, two projection points 20 are formed where the outer circumference of injector socket 14 contacts scalloped feature 24. Projection points 20 are consumed during a projection welding process and the formed bond temporarily holds fuel injector socket 14 and fuel distribution tube 12 together on position until a permanent braze joint is produced during a brazing process.

A braze joint gap 34 is formed between projection points 20 when fuel injector socket 14 mates with fuel distribution tube 12 in scalloped feature 24. Braze joint gap 34 is optimized when projection points 20 are consumed. Accordingly, if the radii 18 and 28 of fuel injector socket 14 and scalloped feature 24, respectively, are set properly, a braze joint with base metal strength that is able to withstand concentrated stress, vibration, and temperature loads may be achieved.

Scalloped feature 26 is designed to receive mounting boss 16. Scalloped feature 26 has a radius 32 that is designed to be larger than a radius 22 of mounting boss 16. As a result, one projection point 30 is formed where the outer circumference of mounting boss 16 contacts scalloped feature 26. Projection point 30 is consumed during a projection welding process and the formed bond temporarily holds mounting boss 16 and fuel distribution tube 12 together on position until a permanent braze joint is produced during a brazing process. Since projection point 30 is formed in the center of scalloped feature 26, scalloped feature 26 may be formed without the center hole and, therefore, may not provide fluid communication with the interior of fuel distribution tube 12.

A braze joint gap 36 is formed at each side of projection point 30 when mounting boss 16 mates with fuel distribution tube 12 in scalloped feature 26. Braze joint gaps 36 are optimized when projection point 30 is consumed. Accordingly, if radii 22 and 32 of mounting boss 16 and scalloped feature 26, respectively, are set properly, a braze joint with base metal strength that is able to withstand concentrated stress, vibration, and temperature loads may be achieved.

It is further possible to design scalloped feature 26 to have a radius 32 that is smaller than radius 22 of mounting boss 16, similar as shown in FIG. 1 for fuel injector socket 16 and scalloped feature 26. In this case, two projection points would be formed where the outer circumference of mounting boss 16 contacts scalloped feature 26. Also in this case, scalloped feature 26 could be formed with a center hole that provides fluid communication with the interior of fuel distribution tube 12. The center hole would enable leak test of the braze joint formed in a brazing process. The leak test may determine if the joint properly filled during brazing.

Scalloped features 24 and 26 may be machined, for example, cut into fuel distribution tube 12. A multi tooled machining head may be used to form scalloped features 24 and 26 in fuel distribution tube 12 concurrently along the preset tooling centerline (not shown). An ultimate centerline of scalloped features 24 and 26 is the result of tooling machine head position and tooling tolerances and does not depend on the straightness of fuel distribution tube 12. Therefore, fuel distribution tube 12 may be a mill quality conduit that is held on the tooling centerline. Fuel injector socket 14 and mounting boss 16 may be relatively simple screw machine parts.

Referring to FIGS. 2 and 3, cross-sectional views of a direct injection fuel rail assembly 40 taken in front of a fuel injector socket 44 and in front of a mounting boss 46, respectively, are illustrated in accordance with a second embodiment of the invention. Direct injection fuel rail assembly 40 includes a fuel distribution tube 42 having at least one fuel injector socket 44 and at least one mounting boss 46 attached.

Fuel distribution tube 42 may be an elongate cylindrical conduit that, contrary to fuel distribution tube 12 shown in FIG. 1, does not have scalloped features included. Fuel distribution tube 42 includes a fuel passage positioned where fuel injector socket 44 is received.

Referring to FIG. 2, a scalloped feature 54 is formed in fuel injector socket 44 for mating with fuel distribution tube 42. Scalloped feature 54 has a radius 58 that is smaller than a radius 48 of fuel distribution tube 42. As a result, two projection points 50 are formed where the outer circumference of fuel distribution tube 42 contacts scalloped feature 54. Projection points 50 are consumed during a projection welding process and the formed bond temporarily holds fuel injector socket 44 and fuel distribution tube 42 together on position until a permanent braze joint is produced during a brazing process.

A braze joint gap 64 is formed between projection points 50 when fuel distribution tube 42 mates with fuel injector socket 44 in scalloped feature 54. Braze joint gap 64 is optimized when projection points 50 are consumed. Accordingly, if the radii 48 and 58 of fuel distribution tube 42 and scalloped feature 54, respectively, are set properly, a braze joint with base metal strength that is able to withstand concentrated stress, vibration, and temperature loads may be achieved.

Referring to FIG. 3, a scalloped feature 56 is formed in mounting boss 46 for mating with fuel distribution tube 42. Scalloped feature 56 has a radius 62 that is larger than radius 48 of fuel distribution tube 42. As a result, one projection point 60 is formed where the outer circumference of fuel distribution tube 42 contacts scalloped feature 56. Projection point 60 is consumed during a projection welding process and the formed bond temporarily holds mounting boss 46 and fuel distribution tube 42 together on position until a permanent braze joint is produced during a brazing process.

A braze joint gap 66 is formed to each side of projection point 30 when mounting boss 16 mates with fuel distribution tube 12 in scalloped feature 26. Braze joint gaps 66 are optimized when projection point 60 is consumed. Accordingly, if radii 48 and 62 of fuel distribution tube 42 and scalloped feature 46, respectively, are set properly, a braze joint with base metal strength that is able to withstand concentrated stress, vibration, and temperature loads may be achieved.

It is further possible to design scalloped feature 56 to have a radius 62 that is smaller than radius 48 of fuel distribution tube 42, similar as shown in FIG. 2 for fuel distribution tube 42 and scalloped feature 54 of fuel injector socket 44. In this case, two projection points would be formed where the outer circumference of fuel distribution tube 42 contacts scalloped feature 56 of mounting boss 46.

By intentionally mismatching the radii of fuel distribution tube 12 or 42 and fuel injector socket 14 or 44 as well as of fuel distribution tube 12 or 42 and mounting boss 16 or 46, projection points are created that can be consumed during a resistance welding process. As the projection points are consumed, the braze joint gap may be optimized and a temporary bond is formed between fuel distribution tube 12 or 42 and fuel injector socket 14 or 44 as well as between fuel distribution tube 12 or 42 and mounting boss 16 or 46, which may enable formation of a braze joint with base metal strength during a brazing process.

While the application of a resistance welding process has been described for a direct injection fuel rail assembly, the concept of intentionally mismatching the radii of components to be assembled using a resistance welding process may be utilized for other applications where cylindrical metal parts need to be joined.

While injector socket 14 and mounting boss 16 are shown in FIG. 1 paired together, other arrangements may be possible.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A method for assembling a fuel rail assembly of an internal combustion engine, comprising the steps of:
providing a fuel distribution tube having a first radius;
mating a fuel rail component having a second radius that is different from said first radius with said fuel distribution tube;
forming at least one projection point where said fuel rail component contacts said fuel distribution tube;
consuming said at least one projection point during a resistance welding process; and
forming a temporary bond between said fuel rail component and said fuel distribution tube.

2. The method of claim 1, further comprising the steps of:
forming a braze joint gap proximate to said at least one projection point; and
optimizing said braze joint gap during consumption of said projection point.

3. The method of claim 1, further comprising the steps of:
holding said fuel rail component and said fuel distribution tube together on position with said temporary bond; and
producing a permanent braze joint during a brazing process.

4. The method of claim 1, further comprising the steps of:
mating an additional fuel rail component having a third radius that is different from said first radius with said fuel distribution tube;
forming at least one additional projection point where said additional fuel rail component contacts said fuel distribution tube; and
consuming said at least one additional projection point during a resistance welding process.

5. The method of claim 1, further comprising the steps of:
forming a scalloped feature having said first radius in said fuel distribution tube;
mating said fuel rail component having said second radius that is larger than said first radius with said scalloped feature;
forming exactly two projection points where said fuel rail component contacts said scalloped feature; and
forming a braze joint gap between said two projection points.

6. The method of claim 1, further comprising the steps of:
forming a scalloped feature having said first radius in said fuel distribution tube;
mating said fuel rail component having said second radius that is smaller than said first radius with said scalloped feature;
forming exactly one projection point where said fuel rail component contacts said scalloped feature; and
forming said braze joint gap at each side of said projection point.

7. The method of claim 1, further comprising the steps of:
forming a scalloped feature having said second radius in said fuel rail component;
mating said fuel distribution tube having said first radius that is larger than said second radius with said scalloped feature;
forming exactly two projection points where said fuel distribution tube contacts said scalloped feature; and
forming a braze joint gap between said two projection points.

8. The method of claim 1, further comprising the steps of:
forming a scalloped feature having said second radius in said fuel rail component;
mating said fuel distribution tube having said first radius that is smaller than said second radius with said scalloped feature;
forming exactly one projection point where said fuel rail component contacts said scalloped feature; and
forming said braze joint gap at each side of said projection point.

9. The method of claim 1, further comprising the step of:
manufacturing said fuel distribution tube from a mill quality conduit.

10. The method of claim 1, further comprising the step of:
manufacturing said fuel rail component as a screw machine part.

11. A method for assembling a fuel rail assembly of an internal combustion engine, comprising the steps of:
forming a first scalloped feature having a first radius in a fuel distribution tube;
forming a second scalloped feature having a second radius in said fuel distribution tube;
mating a first fuel rail component having a third radius that is different from said first radius with said first scalloped feature;
mating a second fuel rail component having a fourth radius that is different from said second radius with said second scalloped feature;
forming at least one first projection point where said first fuel rail component contacts said first scalloped feature;
forming at least one second projection point where said second fuel rail components contacts said second scalloped feature;
temporarily bonding said first fuel rail component to said fuel distribution tube by consuming said first projection point during a projection welding process; and
temporarily bonding said second fuel rail component to said fuel distribution tube by consuming said second projection point during a projection welding process.

12. The method of claim 11, further comprising the steps of:
designing said first radius of said first scalloped feature to be smaller than said third radius of said first fuel rail component;
selecting said first fuel rail component to be a fuel injector socket; and
forming said first scalloped feature in said fuel distribution tube to include a center hole that enables fluid communication with an interior of said fuel distribution tube.

13. The method of claim 12, further including the steps of:
forming two first projection points where said fuel injector socket contacts said fuel distribution tube;
forming a braze joint gap between said two first projection points;
optimizing said braze joint gap during said projection welding process; and
producing a permanent bond between said fuel distribution tube and said fuel injector socket during a brazing process.

14. The method of claim 11, further including the steps of:
designing said second radius of said second scalloped feature to be larger than said fourth radius of said second fuel rail component; and
selecting said second fuel rail component to be a mounting boss.

15. The method of claim 14, further including the steps of:
forming one second projection point where said mounting boss contacts said fuel distribution tube;
forming a braze joint gap at each side of said one second projection point;
optimizing said braze joint gaps during said projection welding process; and
producing a permanent bond between said fuel distribution tube and said mounting boss during a brazing process.

16. The method of claim 11, further including the steps of:
selecting said second fuel rail component to be a mounting boss;
selecting said fourth radius to be larger than said second radius of said second scalloped feature;
forming said second scalloped feature in said fuel distribution tube to include a center hole that enables fluid communication with an interior of said fuel distribution tube;
producing a permanent bond between said fuel distribution tube and said mounting boss during a brazing process; and
leak testing said permanent bond.

17. A method for assembling a fuel rail assembly of an internal combustion engine, comprising the steps of:
providing a fuel distribution tube including a fuel passage and having a first radius;
forming a first scalloped feature having a second radius that is different from said first radius in a first fuel rail component;
forming a second scalloped feature having a third radius that is different from said first radius in a second fuel rail component;
mating said first scalloped feature with said fuel distribution tube at said fuel passage;
mating said second scalloped feature with said fuel distribution tube adjacent to said fuel passage;
forming at least one first projection point where said first fuel rail component contacts said fuel distribution tube;
forming at least one second projection point where said second fuel rail components contacts said fuel distribution tube;
temporarily bonding said first fuel rail component to said fuel distribution tube by consuming said first projection point during a projection welding process; and
temporarily bonding said second fuel rail component to said fuel distribution tube by consuming said second projection point during a projection welding process.

18. The method of claim 17, further including the steps of:
designing said second radius of said first scalloped feature to be smaller than said first radius of said fuel distribution tube; and
selecting said first fuel rail component to be a fuel injector socket.

19. The method of claim 18, further including the steps of:
forming two first projection points where said fuel injector socket contacts said fuel distribution tube;
forming a braze joint gap between said two first projection points;
optimizing said braze joint gap during said projection welding process; and
producing a permanent bond between said fuel distribution tube and said fuel injector socket during a brazing process.

20. The method of claim 16, further including the steps of:
designing said third radius of said second scalloped feature to be smaller or bigger than said first radius of said fuel distribution tube;
selecting said second fuel rail component to be a mounting boss;
forming a braze joint gap proximate to said at least one second projection point;
optimizing said braze joint gap during said projection welding process; and
producing a permanent bond between said fuel distribution tube and said fuel injector socket during a brazing process.
